(19) United States
(12) Patent Application Publication
(10) Pub. No.: US 2004/0045745 A1
(43) Pub. Date: Mar. 11, 2004

(54) Lifting device for an industrial truck

(76) Inventors: Hans-Jorg Schiebel, Kusterdingen (DE); Michael Meinhardt, Reutlingen (DE); Ralf Mebert, Nurtingen (DE)

Correspondence Address: William H. Logsdon, WEBB ZIESENHEIM LOGSDON ORKIN & HANSON, P.C., 700 Koppers Building, 436 Seventh Avenue, Pittsburgh, PA, 15219-1818, US

(21) Appl. No.: 10/459,403

(22) Filed: Jun. 11, 2003

(30) Foreign Application Priority Data
Jun. 14, 2002 (DE) 102 26 601.8

(51) Int. Cl. G01G 19/08

(52) U.S. Cl. 177/136; 177/147; 177/139

(57) ABSTRACT

The invention provides a lifting device for an industrial truck with a load holding device (9) that can move in a vertical direction along a lifting mast. A lifting chain (13) supports the load holding device (9) and a measurement device determines the weight of a load on the load holding device (9). The measurement device includes a force transducer (18) located in the vicinity of the lifting chain (13) of the lifting device. The force transducer (18) is suitable for the measurement of compression forces and is located at a fastening point of the lifting chain (13) to the lifting mast.

### CROSS-REFERENCE TO RELATED APPLICATION

This application corresponds to German Application No. 102 26 601.8, filed Jun. 14, 2002, which is herein incorporated by reference in its entirety.

### BACKGROUND OF THE INVENTION

1. Field of the Invention

This invention relates to an industrial truck lifting device having a load holding device that can be moved in a vertical direction along a lifting mast, a lifting chain that supports the load holding device, and a measurement device for determination of the weight of a load that is being carried on the load holding device.

2. Technical Considerations

On industrial trucks such as fork-lift trucks, reach trucks, high lift stackers, or high lift order pickers, for example, the trucks can be equipped with appropriate measurement devices to determine the weights of the loads on the load holding device. The information concerning the load weight obtained with the measurement device can then be displayed to the operator by means of a display device. The data concerning the weight of the load can be processed in a control system of the industrial truck, which information can be used to influence the traction drive system or the lifting drive system as a function of the weight of the load.

The weight of the load that is on the load holding device can be determined in a very complex and expensive manner by means of a weighing device that is located on the load holding device. However, this approach requires a special construction of the load holding device and the transmission of the measurement signals by means of movable lines. In a less complicated construction, the weight of the load can be estimated as a function of the pressure in a hydraulic lifting cylinder. However, because the pressure in a hydraulic lifting cylinder is also a function of other factors, such as dynamic effects or the friction conditions on the lifting platform, the accuracy of such a measurement is insufficient for many applications.

Therefore, it is an object of the invention to provide a lifting platform for an industrial truck with a simply constructed measurement device for the accurate determination of the weight of a load that is being carried on the load holding device.

### SUMMARY OF THE INVENTION

The invention teaches that the measurement device can include a force transducer, which is located in the vicinity of the lifting chain of the lifting device. When the load is raised off the floor, the full weight of the load is absorbed by the lifting chain. Therefore, the force that is exerted on the lifting chain is a direct function of the weight of the load. Because the lifting chain is fastened directly to the load holding device, when the measurement device is located in the vicinity of the lifting chain there is only a small amount of interference, e.g., as a result of the friction between the load holding device and the lifting mast.

The measurement device can be realized so that the force transducer directly or indirectly measures the tensile force acting on the lifting chain. The weight of the load being lifted creates a tension load that is exerted on the lifting chain which can be measured directly, for example by means of a tension measurement element, or indirectly by means of the reaction forces at a point where the lifting chain is fastened to the load holding device.

In one particularly simple embodiment, the force transducer is suitable for the measurement of compression forces. Conventional sensors for the measurement of compression forces are commercially available and are both accurate and long-lived.

A sensor can be used for the measurement of compression forces if the force transducer is located at a point where the lifting chain is fastened to the lifting mast. At the fastening point, the lifting chain can be connected with the lifting mast, whereby the tension force that is being exerted on the lifting chain is supported on the lifting mast in the form of a compression force.

In one advantageous embodiment of the invention, the force transducer can have at least one continuous measurement transducer or transmitter. A continuous measurement transducer supplies a continuous or finely graduated measurement signal that reflects the weight of the load being lifted with the lifting device. In a control system of the industrial truck, therefore, the output signal of the force transducer can be used to derive an accurate weight of the load.

It is further advantageous if the force transducer has a plurality of, e.g., two, measurement transducers that are independent of each other. Because each measurement transducer supplies a signal which is a function of the weight of the load, there are two redundant measurement signals. These measurement signals can be compared to perform a plausibility check. If the measurement signals are evaluated separately, there is also a redundancy for their further processing steps, as required for safety-relevant functions of industrial trucks.

The fastening point can have a thrust block which can be fastened to the lifting mast, with a fastening piece of the chain guided through the thrust block. The fastening piece can be secured by a locking piece on the side facing away from the lifting chain. The fastening piece suspended on the last link in the chain can have an oblong threaded rod which is stuck through an opening in the thrust block. Two lock nuts can be fixed on the threaded rod and thereby form the locking piece.

In one particularly favorable arrangement, the force transducer can be located between the locking piece and the thrust block. The force transducer can have a ring shape and can be slipped onto the threaded rod of the fastening piece of the chain. The force of the lifting chain can be transmitted by the fastening piece to the force transducer, and from the force transducer to the thrust block.

The invention can be used to particular advantage if the load holding device is guided on a supplemental lifting mast which can be moved up and down, together with the load holding device, by means of a main lifting mast, and if the measurement device is located in the vicinity of the additional lifting mast. Industrial trucks that are realized in the form of high shelf stackers or high shelf order pickers are particularly likely to have an additional lifting mast of this type. The additional lifting mast is thereby generally realized in the form of a simple, non-telescoping lifting mast, as a result of which there is no possibility of an erroneous result of the measurement of the weight of the load caused by the raising of part of the mast.

### BRIEF DESCRIPTION OF THE DRAWINGS

Additional advantages and details of the invention are explained in greater detail below, with reference to the exemplary embodiment illustrated in the accompanying schematic drawings, in which:

FIG. 1 shows an industrial truck in the form of a high shelf stacker;

FIG. 2 shows an additional lifting mast of the high shelf stacker of FIG. 1;

FIG. 3 shows the fastening point of the lifting chain to the additional lifting mast of FIG. 2; and

FIG. 4 shows an exemplary embodiment of an exemplary alternative force transducer structure of the invention.

### DESCRIPTION OF THE PREFERRED EMBODIMENT

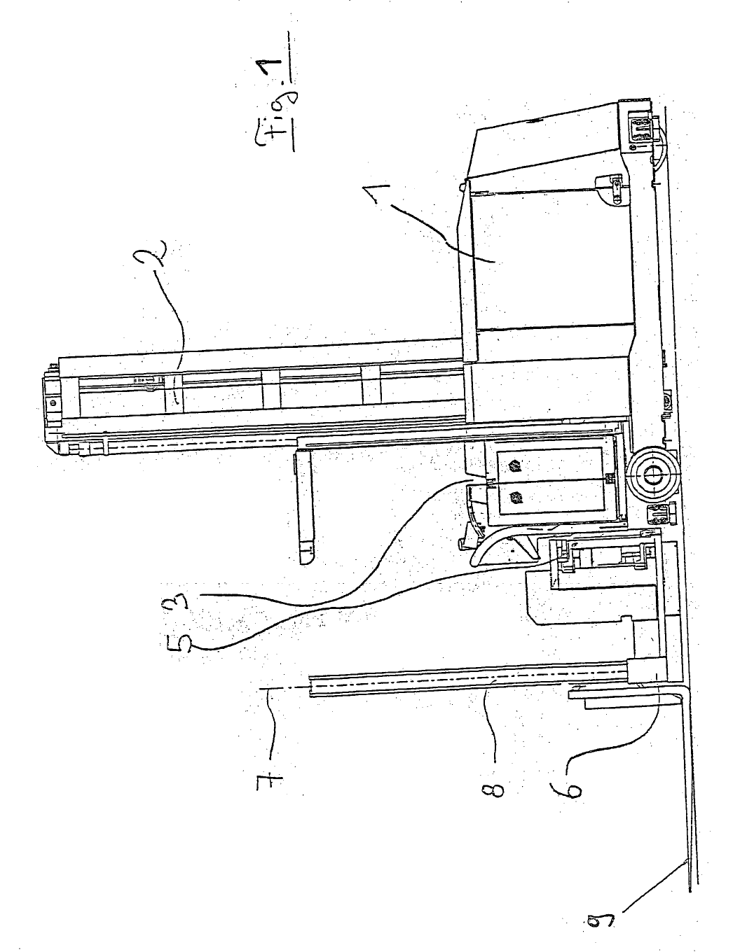

FIG. 1 shows an industrial truck of the invention in the form of a high shelf stacker. The high shelf stacker has a non-elevating truck segment 1 to which a telescoping main lifting mast 2 is fastened. A driver's stand 3 can be raised and lowered along the main lifting mast 2. A load holding device 9 that is realized in the form of a load fork is fastened to the driver's stand 3 by means of various conventional movement devices as are known in the art and can be raised and lowered together with the driver's stand 3 by means of the main lifting mast 2. The movement devices can include a lateral thrust device 5 to move the load holding device 9 in the transverse direction of the high shelf stacker, a pivoting device 6 to pivot the load holding device 9 around the vertical axis 7, and an additional lifting mast 8 to elevate the load holding device 9 relative to the driver's stand 3. The general structure and operation of a conventional high shelf stacker will be understood by one of ordinary skill in the art.

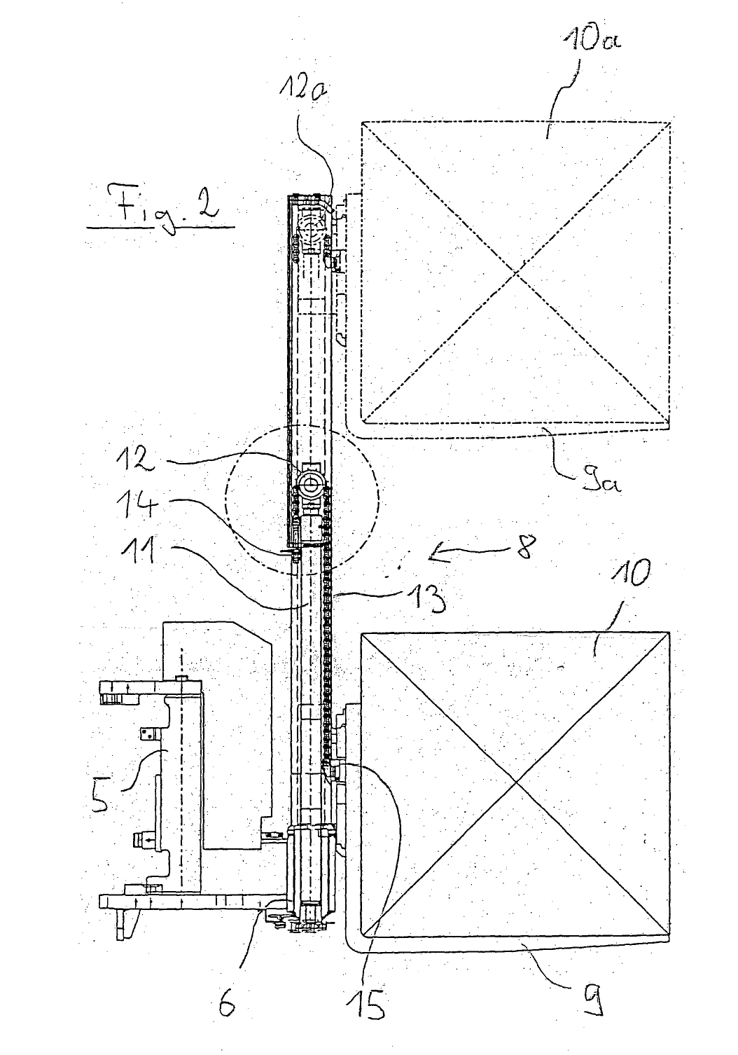

FIG. 2 shows the additional lifting mast 8 of the high shelf stacker, with which the load holding device 9 with a load 10 located on it can be lifted. To lift the load holding device 9 there is a hydraulic lifting cylinder 11, on the extendable piston rod of which there is a pulley 12 for a lifting chain 13. The lifting chain 13 is fastened by means of its one end 14 to the additional lifting mast 8 and by means of its other end 15 to the load holding device 9. By extending the piston rod of the lifting cylinder 11, the pulley 12 is lifted, as a result of which the lifting chain 13 pulls the load holding device 9 upward. The load holding device 9 is thereby raised at a lifting speed which is twice that of the extension movement of the piston. The broken lines show the load holding device 9a, the load 10a and the pulley 12a in the elevated position. The invention teaches that the measurement device for the determination of the weight of the load 10 can be located in the vicinity of the point where the lifting chain 13 is fastened to the additional lifting mast 8.

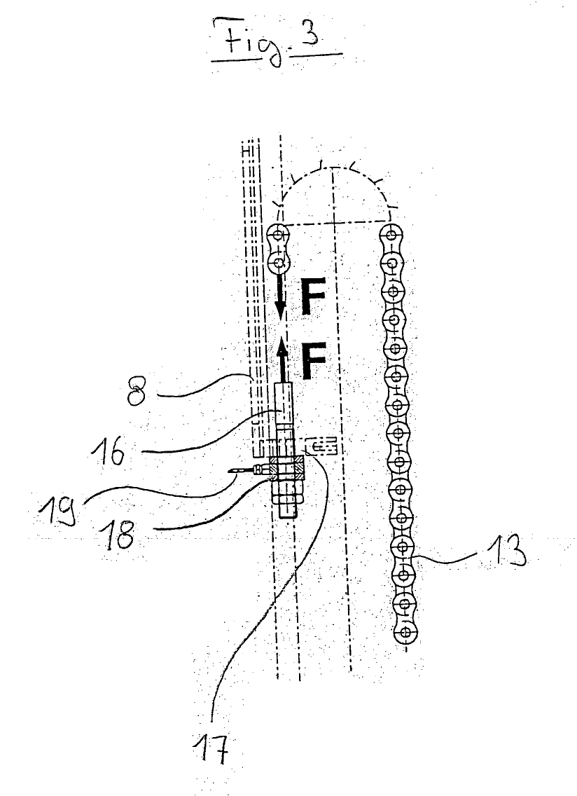

An exemplary embodiment showing the area around one such fastening point is shown enlarged in FIG. 3. The lifting chain 13 supports the weight of the load 10 and of the load holding device 9 with a tension force F. The final link in the lifting chain 13 can be a fastening piece 16. The fastening piece 16 runs through a thrust block 17 which can be attached to a component of the additional lifting mast 8. A force transducer 18 can be slipped over the fastening piece 16 from below to measure compression forces. Underneath the force transducer 18, inserted onto a threaded segment of the fastening piece 16, are two nuts, which thereby form a locking piece which prevents the fastening piece 16 from failing out of the opening of the thrust block 17. The force introduced by the lifting chain 13 into the thrust block 17 of the additional lifting mast 8 is transmitted in the form of a compression force via the force transducer 18. The force transducer 18 generates an electrical signal which is a function of the magnitude of the force which is conducted via a line 19 to a control device of the industrial truck for processing. The line 19 can be realized in the form of a non-moving line, because the position of the force transducer 18 relative to the additional lifting mast 8 does not change.

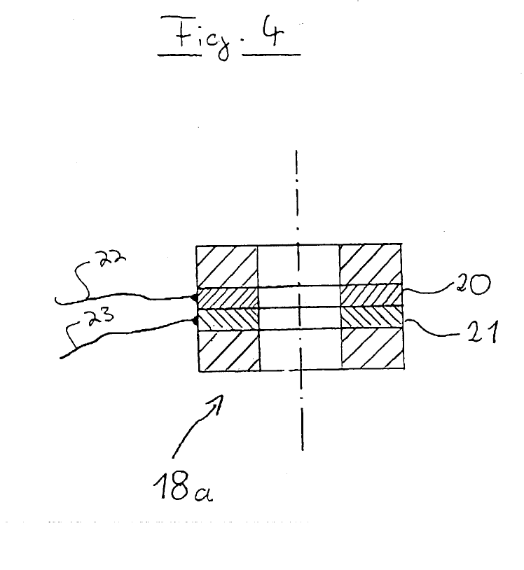

FIG. 4 shows an alternative embodiment of a force transducer structure of the invention. In this embodiment, the force transducer 18a includes a plurality, e.g., two, measurement transducers 20 and 21 that are independent of each other. The transducers 20 and 21 can supply a signal as a function of the weight of the load via lines 22 and 23 to a control device. The redundant measurement signals can be compared to perform a plausibility check. Or, the measurement signals can be separately evaluated to provide redundancy for further processing steps.

As a function of the measured weight of the load, it is possible to determine, for example, the maximum traction speed, the allowable deceleration, or the maximum allowable lifting height. This function can be performed automatically in a control device of the industrial truck.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A lifting device for an industrial truck, comprising:
a load holding device movable along a lifting mast;
a lifting chain supporting the load holding device; and
a measurement device for determination of the weight of a load on the load holding device,
wherein the measurement device comprises a force transducer located in a vicinity of the lifting chain of the lifting device.

2. The lifting device as claimed in claim 1, wherein the force transducer directly or indirectly measures a tension force that is exerted on the lifting chain.

3. The lifting device as claimed in claim 1, wherein the force transducer measures compression forces.

4. The lifting device as claimed in claim 1, wherein the force transducer has at least one continuous measurement transducer.

5. The lifting device as claimed in claim 1, wherein the force transducer comprises two measurement transducers that are independent of each other.

6. The lifting device as claimed in claim 1, wherein the force transducer is located at a fastening point of the lifting chain to the lifting mast.

7. The lifting device as claimed in claim 6, wherein the fastening point includes a thrust block which is fastened to the lifting mast, wherein a fastening piece of the lifting chain runs through the thrust block, and wherein the fastening piece is secured by a locking piece on a side opposite the lifting chain.

8. The lifting device as claimed in claim 7, wherein the force transducer is located between the locking piece and the thrust block.

9. The lifting device as claimed in claim 1, wherein the load holding device is guided on an additional lifting mast, which can be moved up and down together with the load holding device by means of a main lifting mast, and the measurement device is located in the vicinity of the additional lifting mast.

10. The lifting device as claimed in claim 2, wherein the force transducer measures compression forces.

11. The lifting device as claimed in claim 2, wherein the force transducer has at least one continuous measurement transducer.

12. The lifting device as claimed in claim 3, wherein the force transducer has at least one continuous measurement transducer.

13. The lifting device as claimed in claim 2, wherein the force transducer comprises two measurement transducers that are independent of each other.

14. The lifting device as claimed in claim 3, wherein the force transducer comprises two measurement transducers that are independent of each other.

15. The lifting device as claimed in claim 2, wherein the force transducer is located at a fastening point of the lifting chain to the lifting mast.

16. The lifting device as claimed in claim 3, wherein the force transducer is located at a fastening point of the lifting chain to the lifting mast.

17. The lifting device as claimed in claim 4, wherein the force transducer is located,at a fastening point of the lifting chain to the lifting mast.

18. The lifting device as claimed in claim 5, wherein the force transducer is located at a fastening point of the lifting chain to the lifting mast.

19. An industrial truck, comprising:
a lifting device comprising:
a load holding device movable along a lifting mast;
a lifting chain supporting the load holding device; and
a measurement device for determination of the weight of a load on the load holding device,
wherein the measurement device comprises a force transducer located in a vicinity of the lifting chain of the lifting device.

20. The industrial truck as claimed in claim 19, wherein the industrial truck includes a first lifting mast and an additional lifting mast, and wherein the measurement device is attached to the additional lifting mast.
